(19) United States
(12) Patent Application Publication
(10) Pub. No.: US 2008/0296095 A1
(43) Pub. Date: Dec. 4, 2008

(54) HIGH SPEED DIGITAL COMMUNICATION NETWORKS FOR HIGH INTERFERENCE CARGO TRANSPORTATION ENVIRONMENTS

(75) Inventor: DAVID L. FRANK, Boca Raton, FL (US)

Correspondence Address: FLEIT GIBBONS GUTMAN BONGINI & BIANCO P.L., ONE BOCA COMMERCE CENTER, 551 NORTHWEST 77TH STREET, SUITE 111, BOCA RATON, FL, 33487, US

(73) Assignee: Innovative American Technology, Inc., Boca Raton, FL (US)

(21) Appl. No.: 11/928,299

(22) Filed: Oct. 30, 2007

Related U.S. Application Data
(60) Provisional application No. 60/932,687, filed on Jun. 1, 2007.
(60) Provisional application No. 60/933,851, filed on Jun. 9, 2007.

(51) Int. Cl. B66F 9/06; B66C 1/00; H04B 3/00; B66C 5/02

(52) U.S. Cl. 187/237; 187/222; 212/324; 294/81.1; 375/257; 414/460

(57) ABSTRACT

A communication link arrangement for a cargo moving device comprises an electrical infrastructure that is mechanically coupled to a cargo moving device. The cargo moving device includes a cargo retaining structure and a main body coupled to the cargo retaining structure. The electrical infrastructure includes a single conductor electrically coupling the cargo retaining structure and the main body for delivering power and data signals between the cargo retaining structure and the main body. The electrical infrastructure further includes one or more conductors. A first networking element is mechanically coupled to the cargo retaining structure and is electrically coupled to the single conductor. A second networking element is mechanically coupled the main body and is also electrically coupled to the single conductor. A high-speed network link over power line carries data over the single conductor in the electrical infrastructure that supplies power between the main body and the cargo retaining structure.

### CROSS-REFERENCE TO RELATED APPLICATIONS

This application is based on, and claims priority from, prior co-pending U.S. Provisional Patent Application No. 60/932,687 filed on Jun. 1, 2007, by inventor David L. FRANK, and entitled “GANTRY CRANE TO SPREADER BAR HIGH SPEED DIGITAL COMMUNICATIONS”, and further is based on, and claims priority from, prior co-pending U.S. Provisional Patent Application No. 60/933,851 filed on Jun. 9, 2007, by inventor David L. FRANK, and entitled “GANTRY CRANE TO SPREADER BAR AND GANTRY CRANE TO DATA NETWORK HIGH SPEED DIGITAL COMMUNICATIONS”, the entire collective disclosure of all the above-identified applications being hereby incorporated by reference.

### BACKGROUND OF THE INVENTION

1. Field of the Invention

The present invention generally relates to the field of high speed digital communications, and more particularly relates to providing a high speed digital networking environment on cargo moving devices experiencing high interference.

2. Description of Related Art

Shipping yards, trains yards, trucking depots, and other environments where large amounts of cargo are handled utilize various devices for transporting and handling the cargo. For example, gantry cranes and fork-lifts are a few devices used in a shipping yard for transporting cargo containers. Many companies are beginning to implement networking technology on these devices. With respect to gantry cranes, Ethernet over copper technology is being used to provide a network communication link over the existing wiring infrastructure of a gantry crane. In particular, the Ethernet over copper technology utilizes raw copper (i.e., non-twisted pair) that exists within the wiring infrastructure.

The Ethernet over copper technology is problematic because data transfer speeds generally do not exceed 100 kbps (typically 50 kbps) within the gantry crane environment. This is due to the enormous amount of interference that exits within the gantry crane environment and the shipping yard itself. This interference can be (but is not limited to) radio frequency interference (RFI), electromagnetic interference (EMI), and mechanical shock and vibration resulting in electrical interference. This harsh environment drastically reduces the capabilities and functionalities of Ethernet over copper technology. Companies are prevented from implementing applications on cargo moving devices such as gantry cranes that require greater than approximately 100 kbps. The increased bandwidth is difficult to attain due to the high interference environment, which includes those interferences discussed above, and other interferences such as from other high voltage cables in close proximity to the data communication cables and heavy duty motors that cause interference on the copper lines.

An alternative approach is to utilize fiber optic technology. However, installing fiber optic technology on moving devices for transporting and handling cargo is expensive and difficult to maintain in the aggressive environment of a port, train yard, station, or other cargo delivery environment. Furthermore, wireless technology is sometimes used, but experiences large amounts of interference in these harsh environments as well. Furthermore, wireless technologies do not provide the level of security generally required for particular applications being performed in these types of environments.

Therefore a need exists to overcome the problems with the prior art as discussed above.

### SUMMARY OF THE INVENTION

In one embodiment, a communication link arrangement for a cargo moving device is disclosed. The communication link arrangement includes an electrical infrastructure that is mechanically coupled to a cargo moving device. The cargo moving device includes a cargo retaining structure configured to mechanically couple to one or more containers for transporting the one or more containers. A main body is coupled to the cargo retaining structure. The main body comprises controls for operating the cargo retaining structure. The electrical infrastructure comprises a single conductor electrically coupling the cargo retaining structure and the main body for delivering power and data signals between the cargo retaining structure and the main body. The electrical infrastructure further comprises one or more conductors generating power line noise and interference signals that couple to the single conductor. A first networking element is mechanically coupled to the cargo retaining structure and electrically coupled to the single conductor at the cargo retaining structure.

The single conductor at the cargo retaining structure provides power from the main body to one or more components at the cargo retaining structure. A second networking element mechanically coupled the main body and electrically coupled to the single conductor at the main body. A high-speed network link over power line includes the first networking element, the second networking element, and the single conductor. The high-speed network link carries data over the single conductor in the electrical infrastructure that supplies power between the main body and the cargo retaining structure. The data is carried between the first networking element and the second networking element.

In another embodiment, a gantry crane system is disclosed. The gantry crane system includes a spreader bar and a main body coupled to the spreader bar. The main body comprises controls for operating the spreader bar. An electrical infrastructure is mechanically coupled to the main body and the spreader bar. The electrical infrastructure comprises a single conductor electrically coupling the cargo retaining structure and the main body for delivering power and data signals between the cargo retaining structure and the main body. The electrical infrastructure further comprises one or more conductors generating power line noise and interference signals that couple to the single conductor. A first networking element is mechanically coupled to the cargo retaining structure and electrically coupled to the single conductor at the cargo retaining structure.

The single conductor at the cargo retaining structure provides power from the main body to one or more components at the cargo retaining structure. A second networking element mechanically coupled the main body and electrically coupled to the single conductor at the main body. A high-speed network link over power line includes the first networking element, the second networking element, and the single conductor. The high-speed network link carries data over the single conductor in the electrical infrastructure that supplies power between the main body and the cargo retaining structure. The data is carried between the first networking element and the second networking element.

In yet another embodiment, a method for delivering high speed data to a cargo moving device is disclosed. The method includes mechanically coupling an electrical infrastructure to a cargo moving device. A single conductor is electrically coupled within the electrical infrastructure to a cargo retaining structure of the cargo moving device and a main body of the cargo moving device. Power and data signals are delivered in between the cargo retaining structure and the main body response to the electrically coupling. The electrical infrastructure comprises one or more conductors generating power line noise and interference signals that couple to the single conductor. A first networking element is mechanically coupled to the cargo retaining structure. The first networking element is electrically coupled to the single conductor. Power is provided via the single conductor from the main body to one or more components at the cargo retaining structure. A second networking element is mechanically coupled to the main body. The single conductor is electrically coupled to the main body. A high-speed network link over power line is established and comprises the first networking element, the second networking element, and the single conductor. Data is transferred over the single conductor in the electrical infrastructure that supplies power between the main body and the cargo retaining structure, between the first networking element and the second networking element.

One advantage of the various embodiments of the present invention is that high speed networks can be deployed within a high interference cargo transportation environment such as shipping yards, train yards, stations, and the like. These high speed networks are created using power line wires existing between cargo coupling components such as (but not limited to) a spreader bar of a gantry crane to other parts of the cargo moving system such (but not limited to) a gantry crane control room. These high speed networks, according to the present invention, are much more resistant to the large amounts of interference experienced in such harsh environments than conventional networking technologies used in the past. Therefore, the various embodiments of the present invention provide much higher throughput data rates and more reliable communication than what has been available in the past.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a block diagram illustrating one example of providing a high speed network to cargo moving devices in a high interference environment, according to an embodiment of the present invention;

FIG. 2 is a schematic illustrating a “baloney cable”;

FIG. 3 is a block diagram illustrating another example of providing a high speed network to cargo moving devices in a high interference environment, according to an embodiment of the present invention; and

FIG. 4 is a block diagram illustrating yet another example of providing a high speed network to cargo moving devices in a high interference environment, according to an embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure and function. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

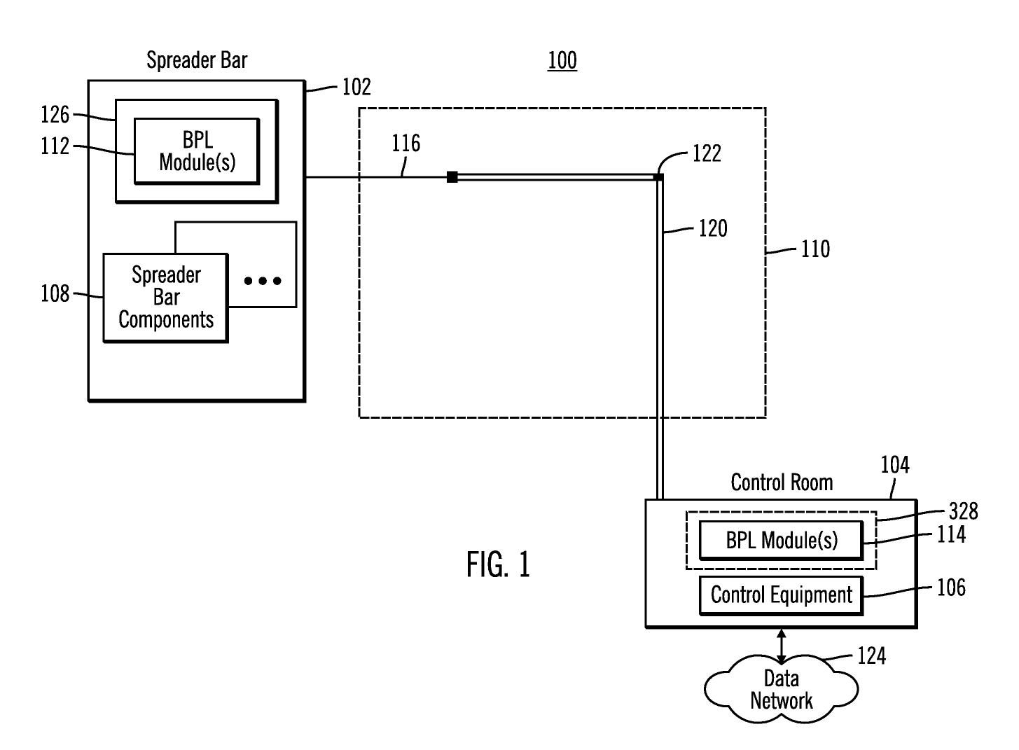

FIG. 1 is a block diagram illustrating one example of providing high-speed network communications in a high-interference environment such as those in cargo moving environments. In particular, FIG. 1 shows a gantry crane system 100 used for transporting cargo containers. Gantry crane systems 100 can be located on land or on a ship. It should be noted that the present invention in not limited to gantry cranes and is applicable to other cargo devices such as fork-lifts or other container moving devices.

A gantry crane system 100, in one embodiment, comprises a spreader bar 102 sometimes referred as a hoist attachment, yoke, or grabber. The spreader bar 102 is generally attached to a hoist mechanism (not shown) for adjusting the position of the spreader bar 102 either vertically or horizontally. This allows the spreader bar 102 to couple to one or more containers for loading and unloading the containers on/off a ship. It should be noted that the present invention is not limited to a spreader bar. Other cargo retaining structures such as (but not limited to) forks on a fork lift and reacher bars are also applicable.

The gantry crane system 100 also includes a gantry crane equipment room 104 that houses the control equipment 106 for the spreader bar 102. For example, the gantry crane equipment room 104 can house the equipment 106 that an operator uses to interact with the spreader bar 102 for moving cargo containers. It should be noted that the gantry crane system 100 can also be a mobile or semi-mobile system comprising wheels, tracks, or any other component that allows the system 100 be re-located. In this embodiment, the gantry crane equipment room 104 can also include controls for moving the gantry crane system 100.

The spreader bar 102 includes various components 108 such as electronics, controls, video systems, data systems, and sensors. Each of these components allow the spreader bar 102 to perform its function of transporting cargo container and/or or more other functions. For example, the various components 108 can comprise radiation/explosive sensors for detecting and identifying radioactive, explosive, and special materials within a shipping container. This operation of detecting and identifying radioactive, explosive, and special materials within a shipping container using sensors deployed on a spreader bar is further discussed in U.S. Pat. No. 7,142,109, by David L. Frank, the teachings of which being hereby incorporated by reference in their entirety.

Video systems and other data collection systems can also be deployed on the spreader for collection various types of data associated with a cargo container, the spreader bar 102, the gantry crane system 100, and the gantry crane system environment. Therefore, in one embodiment, a high speed network 110 is provided among the various components of the gantry crane system 100. This high speed network 110 allows data collected by sensors or other components 108 that are deployed on the spreader bar 102 to be communicated to other systems, the gantry control room 104, or a remote information processing systems communicatively coupled to the gantry crane system 100.

Also, the high speed network 110 allows various components such as cameras, sensors, motors on the spreader bar 102 or any other components to be configured as network nodes. Stated differently, components can be connected to the high speed network 110 as individually addressable network elements. For example, sensors on the spreader bar 102 can each be individually addressable network components that can be controlled through the high speed network 110. As can be seen, providing a high speed network 110 to the various gantry crane system components not only allows data to be collected from these components but also allows each component to be operated through the high speed network. The high speed network 110 allows these components to be operate either locally by someone in the gantry crane control room 104 or at a remote location(s).

As stated above, most networking technologies available today are vulnerable to the harsh environments of gantry cranes systems 100. The Radio Frequency Interferences (“RFIs”) and Electromagnetic Interferences (“EMIs”) created by the gantry crane system 100 itself drastically reduce the throughput rate of most networking technologies. Therefore, one embodiment of the present invention utilizes Broadband Over Power line (“BPL”) modules 112, 114 within the gantry crane system 100. These BPL modules 112, 114 create the high speed communications network 110 over the existing electrical infrastructure, mainly the power lines, of the gantry crane system 100. The electrical infrastructure further comprises one or more conductors generating power line noise and interference signals that couple to the single conductor. The BPL modules 112, 114 comprise all of the necessary components such as (but not limited to) network interface cards, gateways, modems, and hubs needed to create, maintain, and manage the high speed network 110.

FIG. 1 shows one example of using the BPL modules 112, 114 to create a conductive high speed network 110 between the spreader bar 102 and the a main body of such as the gantry crane control room 104. It should be noted that any type of BPL equipment can be used such as (but not limited to) the BPL Access products from Corinex Communications (See www.Corinex.com). As discussed above, the BPL modules 112, 114 use the electrical infrastructure of the gantry crane system 100 to create high speed communications backbone. Multiple BPL modules 112, 114 can be used to create an intelligent networking grid. The high speed network 110 created by the BPL modules 112, 114 over the power lines of the gantry crane system 100 is resistive to the RFI and EMI interferences of the gantry crane system 100 and its environment.

Therefore, much higher throughout speeds can be achieved as compared to the traditional Ethernet over copper technology discussed above. For example, throughput seeds of up to 200 mbps can be achieved over the power lines of the gantry crane system 100 as compared to the 100 kbps achieved when using standard Ethernet over copper. In one embodiment, the BPL modules 113, 114 utilize spread spectrum technology to compensate for interference experienced in the working environment. Also, personnel can select various frequency ranges such as low, medium, and high when implementing the BPL modules 112, 114. In one real-world scenario, implementing the BPL modules 112, 114 over power lines comprising low voltage frequencies such as (but not limited to) 2 to 34 MHz resulted in 45-50 Mbps throughput.

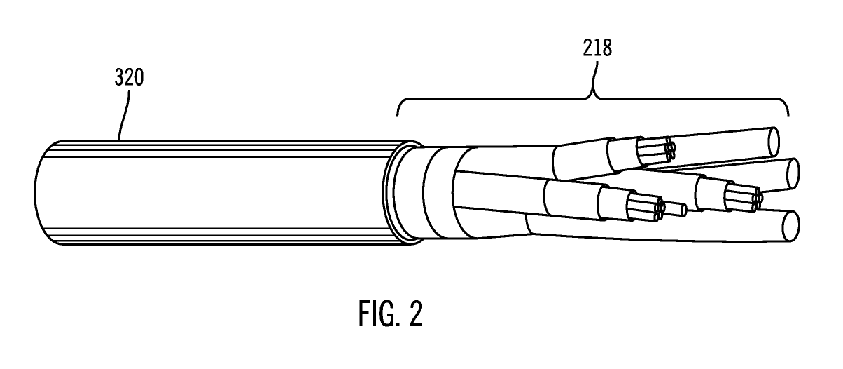

In one embodiment, each of the spreader bar components 108 are communicatively coupled to at least a first networking component such as one or more BPL modules 112 residing on the spreader bar 102. Conventional copper wires (e.g., conductors) situated on the spreader bar 102 that supply power to each of the spreader bar components can be used to communicatively couple the spreader bar components to the BPL module 112. Gantry crane systems 100 generally comprise conductors such as (but not limited to) cables 116 referred as “baloney cables” 116 that are used throughout the system 100. A conductor electrically couples the cargo retaining structure such as a spreader bar 102 and the main body such as the control room 104 for delivering power and data signals between the cargo retaining structure and the main body. A “baloney cable” comprises a plurality of individual cables. For example, FIG. 2 shows one example of a “baloney cable” 216. As can be seen the baloney cable 216 includes a plurality of cables 218 each capable of being used for different purposes. In one embodiment, one or more of these individual cables are used to supply power to the spreader bar 102.

Therefore, the “baloney cable(s)” 116 is communicatively coupled to the BPL module 112 at the spreader bar 102. This cable 116 can either be directly coupled to the gantry crane control room 104 or be communicatively coupled to another set of cables 120 that are directly coupled to the gantry crane control room 104. In one embodiment, the “baloney cable(s)” 116 and the other set of cables 120 are coupled to each other via a rotary joint 122. It should be noted that a rotary joint 122 is only used as one example of how cables can be coupled to one another. Furthermore, rotary joints 122 generate large amounts of interference which conventional network technologies generally can not compensate for.

However, by utilizing the high speed network 110 created by the BPL devices 112, 114 over the electrical infrastructure of the gantry crane system 100, the various embodiments of the present invention are able to achieve much higher throughput rates even when operating near high interference components such as rotary joints 122. The other cable set 120 is communicatively coupled to a BPL module 114 at the gantry crane control room 104, thereby creating the high speed network 110 discussed above. Each of the BPL module 112, 114 can be communicatively coupled to a data network 124 such as the Internet, LAN, WAN, or any other type of network.

In one embodiment, the high-speed network 110 is a high-speed network link over power line comprising the BPL 112, 114 modules and at least one conductor such as the baloney cable 116. This high-speed network link carries data over the single conductor in the electrical infrastructure that supplies power between the main body and the cargo retaining structure, and the data is carried between the BPL modules 112, 114

It should be noted that in one embodiment, each of the BPL modules 112, 114 can reside within an anti-vibration housing 126, 128. By mounting these BPL modules 112, 114 in a shock absorbing housing, which can be shock mounted onto the spreader bar 102 or in within the gantry crane control room 104 enables a rugged design that can withstand shock forces up to a 200 G-force every minute for an extended period of time. This further enables the high-speed network 110 to be implemented via the electrical infrastructure of the gantry crane system 104.

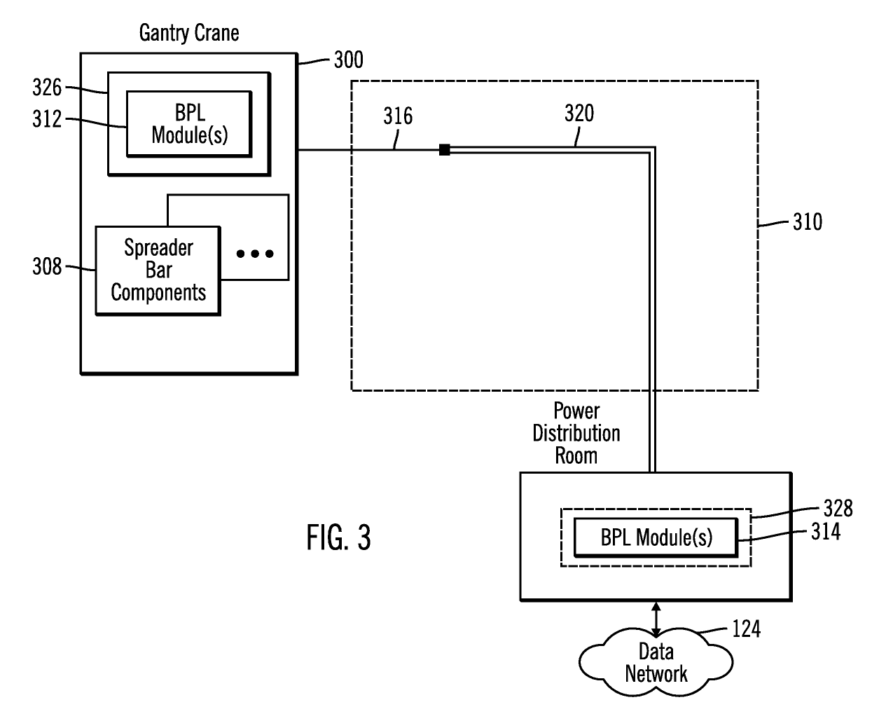

FIG. 3 shows another example of a high-speed network communications in a high-interference environment such as a gantry crane system. In particular, FIG. 1 shows a gantry crane 300, which can comprises the spreader bar 102, hoist attachment and mobile components discussed above. The gantry crane 300 comprises the spreader bar components 308 and the BPL module 312 as discussed above. The spreader bar components 308, in one embodiment, are communicatively coupled to the BPL module 312. Instead of being coupled to the “baloney cable” 116 discussed above, the BPL module 312 of FIG. 3 is coupled to a high voltage power cable 316 existing between the gantry crane 300 and a power distribution center 304.

The high voltage power cable 316 provides power generated by the power distribution center 304 to the gantry crane 300, thereby powering the crane 300 and its components. For example, the gantry crane 300 can (but is not limited to) move along a track which comprises the high voltage power cable 316. The high voltage power cable 316 is communicatively coupled to a BPL module 314 at the power distribution center 304, thereby creating a high-speed network 410 between the gantry crane 300 and the power distribution center 304 using the existing electrical infrastructure of the gantry crane system. Similar to FIG. 1, the BPL modules 312, 314 can be housed within an anti-vibration/shock housing 326, 328.

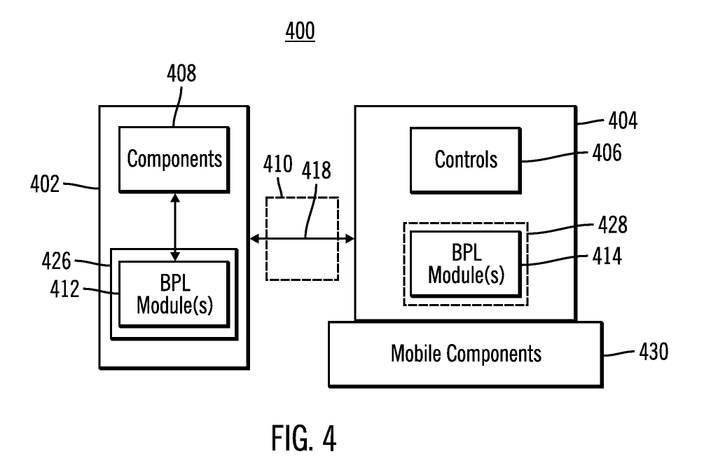

FIG. 4 shows yet another example of providing high-speed network communications in a high-interference cargo moving environment. In particular, FIG. 4 shows another type of cargo moving device 400 such as a fork-lift, crane, or any other mobile or semi-mobile device capable of moving cargo. The cargo moving device 400 includes a cargo coupling component 402 that interacts with the cargo to lift or lower the cargo. The cargo moving device 400 also includes a main body 404 where an operator can operate the cargo moving device 400. A mobile component 430 such as wheels, tracks, treads, or similar component are coupled to the cargo moving device 400 for moving the device 400.

In one embodiment, the cargo coupling component 402 comprises various components 408 such as (but not limited to) forks to lift and lower cargo, sensors, video systems, data systems, and controllers. The main body 404 comprises controls 406 for operating the cargo moving device 400. Each of the cargo coupling component 402 and the main body 404 include one of more BPL modules 412, 414 residing within optional anti-vibration/shock housings 426, 428. These modules 412, 414 are communicatively coupled to each other via the electrical infrastructure 418 of the cargo moving device 400 thereby creating a high speed network 410 similar to that already discussed above.

It should be noted that prior to the aforementioned embodiments, high interference environments such as shipping yards generally only used Fiber Optic technology, Ethernet over copper, or wireless technologies as discussed above. These technologies were either too expensive, could not provide more than 100 kbps data throughput as a result of the interferences experienced, or had security vulnerabilities. As can be seen from the above discussion, the various embodiments of the present invention support high speed digital communications across conventional power line copper wires existing between cargo coupling components such as (but not limited to) a spreader bar of a gantry crane to other parts of the cargo moving system such (but not limited to) a gantry crane control room.

BPL modules are coupled to each of these components in optional anti-shock housing to create a high speed network over the existing electrical infrastructure of the cargo moving system. For example, BPL modules can be connected to copper wires within the spreader bar to gantry crane baloney cable and extended to the gantry crane communications room. The BPL technology can also be deployed on the gantry crane power supply cables to enable high speed data connections between communications networks and the gantry crane within a high interference environment.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A communication link arrangement for a cargo moving device, comprising:
an electrical infrastructure mechanically coupled to a cargo moving device, the cargo moving device comprising:
a cargo retaining structure configured to mechanically couple to one or more containers for transporting the one or more containers; and
a main body coupled to the cargo retaining structure, wherein the main body comprises controls for operating the cargo retaining structure; and
wherein the electrical infrastructure comprises a single conductor electrically coupling the cargo retaining structure and the main body for delivering power and data signals between the cargo retaining structure and the main body, and wherein the electrical infrastructure further comprises one or more conductors generating power line noise and interference signals that couple to the single conductor;
a first networking element mechanically coupled to the cargo retaining structure and electrically coupled to the single conductor at the cargo retaining structure, wherein the single conductor at the cargo retaining structure provides power from the main body to one or more components at the cargo retaining structure;
a second networking element mechanically coupled the main body and electrically coupled to the single conductor at the main body; and
a high-speed network link over power line comprising the first networking element, the second networking element, and the single conductor, and wherein the high-speed network link carries data over the single conductor in the electrical infrastructure that supplies power between the main body and the cargo retaining structure, and the data is carried between the first networking element and the second networking element.

2. The communication link arrangement of claim 1, wherein the high-speed network link carries data over the single conductor in the electrical infrastructure using spread spectrum communication via the single conductor while it supplies power between the main body and the cargo retaining structure, and the spread spectrum communication data is carried between the first networking element and the second networking element.

3. The communication link arrangement of claim 2, wherein the spread spectrum communication via the single conductor operates at a frequency range of approximately 2 to 34 MHz.

4. The communication link arrangement of claim 1, wherein the high-speed network link over power line comprises the first networking element, the second networking element, the single conductor, and a rotary joint, wherein the single conductor is electrically coupled to the rotary joint for delivering power and data signals between the cargo retaining structure and the main body through the single conductor and the rotary joint.

5. The method of claim 1, wherein the cargo moving device is one of:
a gantry crane system;
a fork lift;
a straddle carrier; and
a reach spreader.

6. The method of claim 1, wherein the cargo retaining structure is one of:
a set of forks on a fork-lift device; and
a spreader bar.

7. A gantry crane system, comprising:
a spreader bar;
a main body coupled to the spreader bar, wherein the main body comprises controls for operating the spreader bar;
an electrical infrastructure mechanically coupled to the main body and the spreader bar, wherein the electrical infrastructure comprises a single conductor electrically coupling the spreader bar and the main body for delivering power and data signals between the spreader bar and the main body, and wherein the electrical infrastructure further comprises one or more conductors generating power line noise and interference signals that couple to the single conductor;
a first networking element mechanically coupled to the spreader bar and electrically coupled to the single conductor at the spreader bar, wherein the single conductor at the spreader bar provides power from the main body to one or more components at the spreader bar;
a second networking element mechanically coupled the main body and electrically coupled to the single conductor at the main body; and
a high-speed network link over power line comprising the first networking element, the second networking element, and the single conductor, and wherein the high-speed network link carries data over the single conductor in the electrical infrastructure that supplies power between the main body and the spreader bar, and the data is carried between the first networking element and the second networking element.

8. The gantry crane system of claim 7, wherein the high-speed network link carries data over the single conductor in the electrical infrastructure using spread spectrum communication via the single conductor while it supplies power between the main body and the cargo retaining structure, and the spread spectrum communication data is carried between the first networking element and the second networking element.

9. The gantry crane system of claim 8, wherein the spread spectrum communication via the single conductor operates at a frequency range of approximately 2 to 34 MHz.

10. The gantry crane system of claim 7, wherein the high-speed network link over power line comprises the first networking element, the second networking element, the single conductor, and a rotary joint, wherein the single conductor is electrically coupled to the rotary joint for delivering power and data signals between the cargo retaining structure and the main body through the single conductor and the rotary joint.

11. A method for delivering high speed data about a cargo moving device, the method comprising:
mechanically coupling an electrical infrastructure to a cargo moving device;
electrically coupling a single conductor within the electrical infrastructure to a cargo retaining structure of the cargo moving device and a main body of the cargo moving device;
delivering power and data signals, in response to the electrically coupling, between the cargo retaining structure and the main body, and wherein the electrical infrastructure comprises one or more conductors generating power line noise and interference signals that couple to the single conductor;
mechanically coupling a first networking element to the cargo retaining structure;
electrically coupling the first networking element to the single conductor;
providing power, via single conductor, from the main body to one or more components at the cargo retaining structure;
mechanically coupling a second networking element to the main body;
electrically coupling the single conductor to the main body;
establishing a high-speed network link over power line comprising the first networking element, the second networking element, and the single conductor; and
transferring data over the single conductor in the electrical infrastructure that supplies power between the main body and the cargo retaining structure, between the first networking element and the second networking element.

12. The method of claim 11, wherein the transferring data further comprises:
transferring data over the single conductor in the electrical infrastructure using spread spectrum communication via the single conductor while it supplies power between the main body and the cargo retaining structure, and the spread spectrum communication data is carried between the first networking element and the second networking element.

13. The method of claim 12, wherein the spread spectrum communication via the single conductor operates at a frequency range of approximately 2 to 34 MHz.

14. The method of claim 11, further comprising:
electrically coupling the single conductor a rotary joint for delivering power and data signals between the cargo retaining structure and the main body through the single conductor, wherein the high-speed network link over power line comprises the first networking element, the second networking element, the single conductor, and a rotary joint.

15. The method of claim 11, wherein the cargo moving device is one of:
a gantry crane system;
a fork lift;
a straddle carrier; and
a reach spreader.

16. The method of claim 11, wherein the cargo retaining structure is one of:
a set of forks on a fork-lift device; and
a spreader bar.
